(19) United States
(12) Patent Application Publication
(10) Pub. No.: US 2009/0263540 A1
(43) Pub. Date: Oct. 22, 2009

(54) Process and apparatus for reusing energy recovered in alcohol production

(75) Inventors: Phil Allen, Muscatine, IA (US); Rick Whittaker, Muscatine, IA (US)

Correspondence Address: Brown, Winick, Graves, Gross, Baskerville;and Schoenebaum, P.L.C, 666 Grand Ave, Suite 2000, Des Moines, IA, 50309, US

(73) Assignee: Heartland Renewable energy, LLC

(21) Appl. No.: 12/148,611

(22) Filed: Apr. 21, 2008

(51) Int. Cl. C12C 11/00

(52) U.S. Cl. 426/11; 99/276

(57) ABSTRACT

A process for producing ethanol wherein stillage is recycled into the process as a source of heat and power. Specifically, stillage is spray dried and then combusted in a biomass boiler. Spray drier exhaust is exported to the main scrubber and employed to extract particulates. Flue gas from the boiler is used to produce high pressure steam and the cooled gas is recycled back to the spray dryer as a heat source. The high pressure steam is used by a turbine generator which in turn produces electric power and low pressure steam both of which are returned to the process. Ash remaining after combustion may be used as a fertilizer.

### FIELD OF THE INVENTION

The invention relates to a biofuel production process, and, in particular, to a process whereby certain by-products are treated and combusted to be used by the process as an energy source.

### BACKGROUND

Biofuels-based alcohol production as an alternative to fossil fuel recovery and production has become increasingly popular in the past decade. The biofuel base or feedstock may be any of a number of options including, but unlikely limited to, corn, soybeans, stover, sugarbeets, molasses, crop residues, and livestock waste. Regardless of the biofuel source, processing the source to a usable form requires energy and produces a variety of byproducts and waste streams. As competition tightens in the industry, margins become thinner and producers look for higher efficiency methods of production. Further, producers need to identify high value byproducts and markets for those, as well.

What is needed is a biofuel production process wherein waste streams are converted to useful energy sources or into value-added products without adding net costs to the production process and/or adding negative environmental impact.

It is therefore one object of the present invention to employ an alcohol production process and apparatus that allows drying of at least one of the byproducts for conversion to energy;

It is a second object of the present invention to harvest various waste streams from said process, re-introduce those waste streams at appropriate stages and through specified equipment in order to reduce net energy use;

It is a third object of the present invention to utilize at least one waste stream of negligible market value to create power and reduce the net energy use of the entire process, therefore creating a net benefit.

### SUMMARY OF THE INVENTION

The present invention comprises a process by which a biofuel is used to produce an alcohol wherein the alcohol may be used as a combustible fuel. The biofuel is fermented and then one of two processes occurs. Either the suspended solids are removed to produce clarified liquor including soluble solids and alcohol and then, once alcohol is removed from the clarified liquor, a thin stillage with no suspended solids remains. Or the alcohol is first removed through distillation processes and then suspended solids are removed resulting in thick stillage and thin stillage. Thereafter, the liquid is evaporated from the thin stillage leaving a condensed stillage and the evaporated gases are condensed to a condensate which is then subjected to reverse osmosis. The reverse osmosis permeate, nearly pure water, is sent to various scrubbers or other aspects of the process where water is used. The retentate is recycled back into the suspended and or soluble solids mixture and through the evaporation process.

After the liquid is evaporated the condensed stillage remains. Preferably, the condensed stillage is about 50% by weight total solids and may be called syrup. When condensed stillage is a byproduct of corn ethanol production, it is often sold as Condensed Distillers Solubles (CDS) for a feed source in livestock production. The thick stillage of corn ethanol production is dried a bit further and sold as dry distiller's grains for the same purpose. However, the market for CDS and distiller's grains has become oversupplied and market prices reflect that position. Further, when ethanol is produced from biofuels other than corn, the condensed stillage may not have adequate nutrients for use as a livestock feed supplement and may command even lower prices, if any at all. Specifically, molasses based ethanol production produces Condensed Molasses Solubles of little food value.

The present invention uses the thin stillage in a novel way as a heat source for use in various parts of the production process. First, the thin stillage is evaporated to a syrup (also known as condensed stillage); then the syrup or condensed stillage is spray dried. Excess heat from the drying step is provided to the main scrubber where pollutants and heat are removed from the gas stream. The condensed stillage is spray dried to a usable solid form, termed a biomass. The biomass is preferably over about 80% total solids by weight resulting in a biomass. Exhaust from the spray dryer (with a temperature of somewhere around 200 degrees Fahrenheit) is also routed to the main scrubber where pollutants and heat are removed.

Once spray dried, the resulting biomass is sent to a biomass boiler where it is combusted resulting in heat production and ash. In the preferred embodiment, the biomass after spray drying is over about 80% by weight total solids. The heat produced by combustion provides high heat gases of between about 1600 and 2000 degrees Fahrenheit. The high heat gases transfer heat via boiler tubes to create high pressure steam, about 200 psig and around 400 degrees Fahrenheit. The cooled gas (usually around 700 degrees) is then routed to the spray drier for use in that process step. The high pressure steam is used by a turbine generator for conversion to electrical power which may then be used in various steps of the process or in the production plant. In addition to production of electrical power, the turbine generator also expels low pressure steam (generally about 30 psig and around 250 degrees Fahrenheit) which is also routed back into the process where needed.

Ash produced from combustion of the biomass is sent to a baghouse where it is removed from the gas stream. The collected ash can then be sold and used as fertilizer. In the preferred embodiment, the ash fertilizer comprises about 30% potash. Exhaust from the baghouse is expelled or scrubbed, if needed.

Various gaseous exhaust streams from the process are sent to the Main Scrubber. Cleaned exhaust from the main scrubber in the preferred embodiment is split between a particulate scrubber and the spray dryer. In the spray drying step, this exhaust is both a source of heat and airflow. Permeate from the particulate scrubber, usually fairly warm at around 135 degrees Fahrenheit is sent back to be used in the early process step of dilution or fermentation and the remaining clean gas sent into the atmosphere near 90 degrees.

Other objects, features, and advantages of the present invention will be readily appreciated from the following description. The description makes reference to the accompanying drawings, which are provided for illustration of the preferred embodiment. However, such embodiment does not represent the full scope of the invention. The subject matter which the inventor does regard as his invention is particularly pointed out and distinctly claimed in the claims at the conclusion of this specification.

### BRIEF DESCRIPTION OF THE DRAWINGS

FIG. 1 is a simplified schematic process flow diagram of a process and apparatus for producing ethanol using molasses as the biofuel;

FIG. 2 is a simplified schematic process flow diagram of Stages I and II of the present invention;

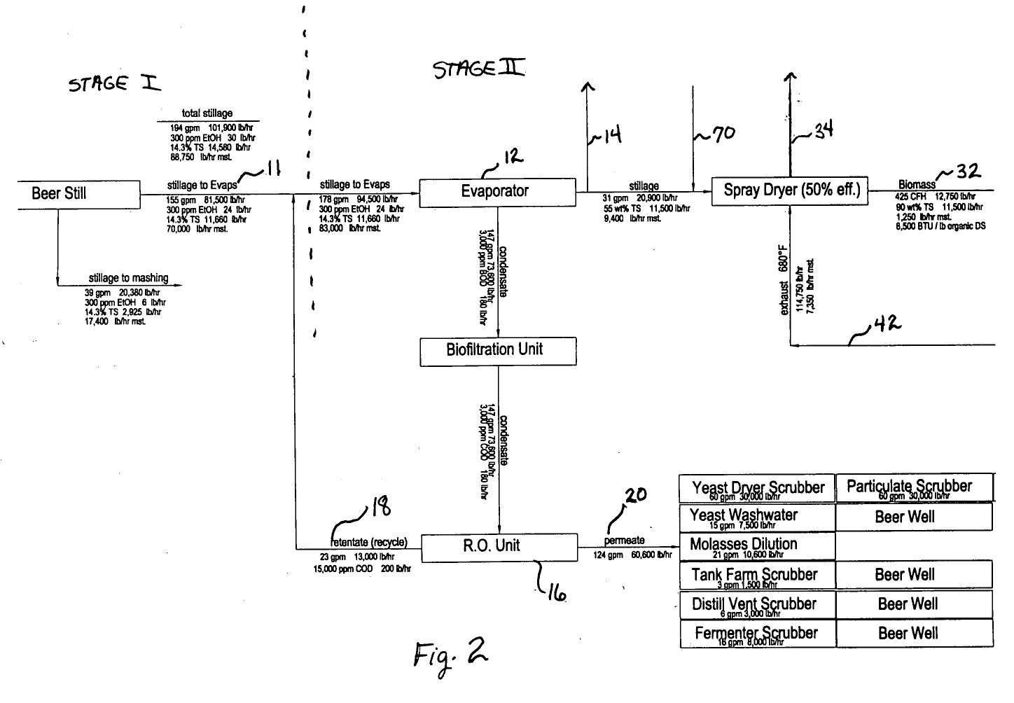

FIG. 3 is a simplified schematic process flow diagram of Stage III of the present invention; and

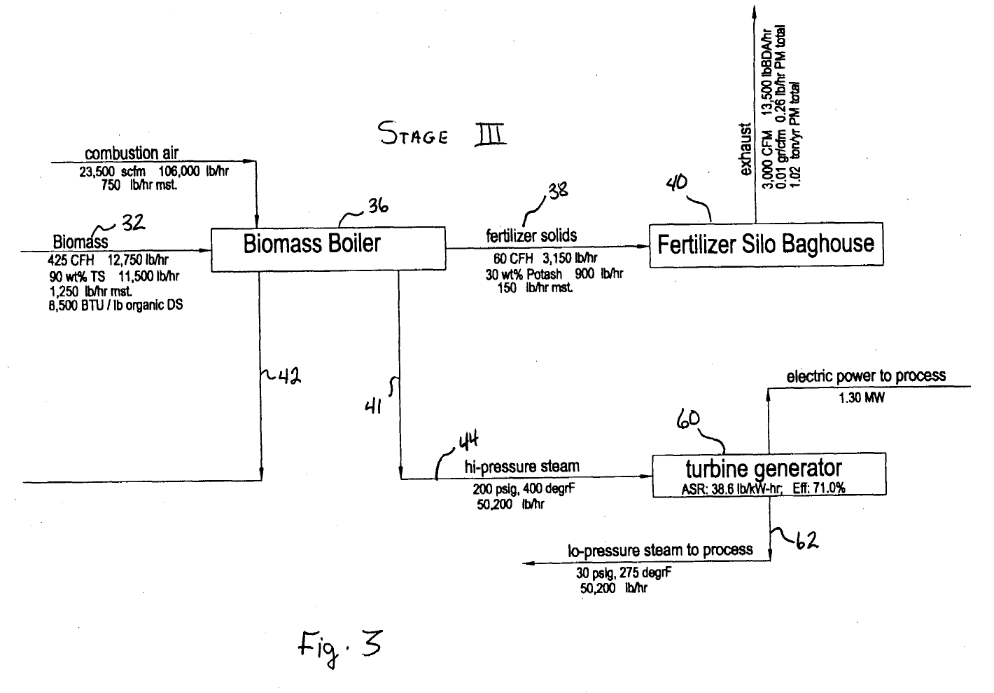

FIG. 4 is a simplified schematic process flow diagram of Stage IV of the present invention.

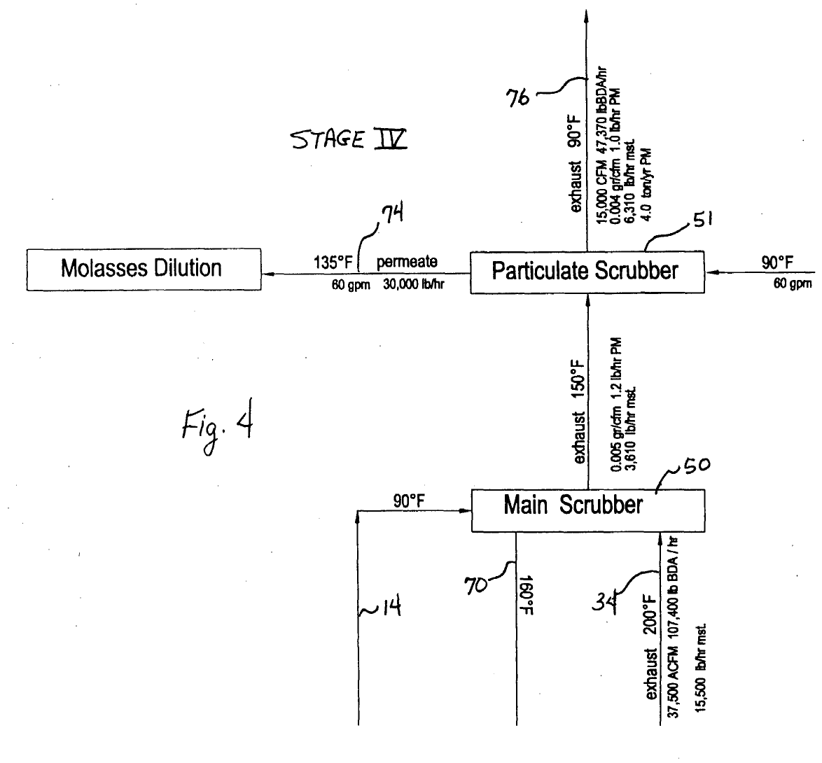

### Reference Key:

10 beer still
11 clarified or condensed stillage
12 evaporator/means for evaporating liquid
14 first waste stream
15 condensate
16 means for cleaning condensate
18 retentate
20 permeate
30 means for drying stillage
32 biomass
34 second waste stream
36 biomass boiler/means for combusting biomass
38 ash
40 baghouse
42 third waste stream (cooler waste stream
41 fourth waste stream (high heat waste stream)
44 high pressure steam
50-55 Plurality of means for removing pollutants from a gaseous stream
50 Main Scrubber
51 Particulate Scrubber
60 means for generating power
62 fifth waste stream (low pressure steam)
70 first output from Main Scrubber
72 second output from Main Scrubber
74 partially cooled from Particulate Scrubber
76 cooled stream from Particulate Scrubber

### DETAILED DESCRIPTION OF THE PREFERRED EMBODIMENT

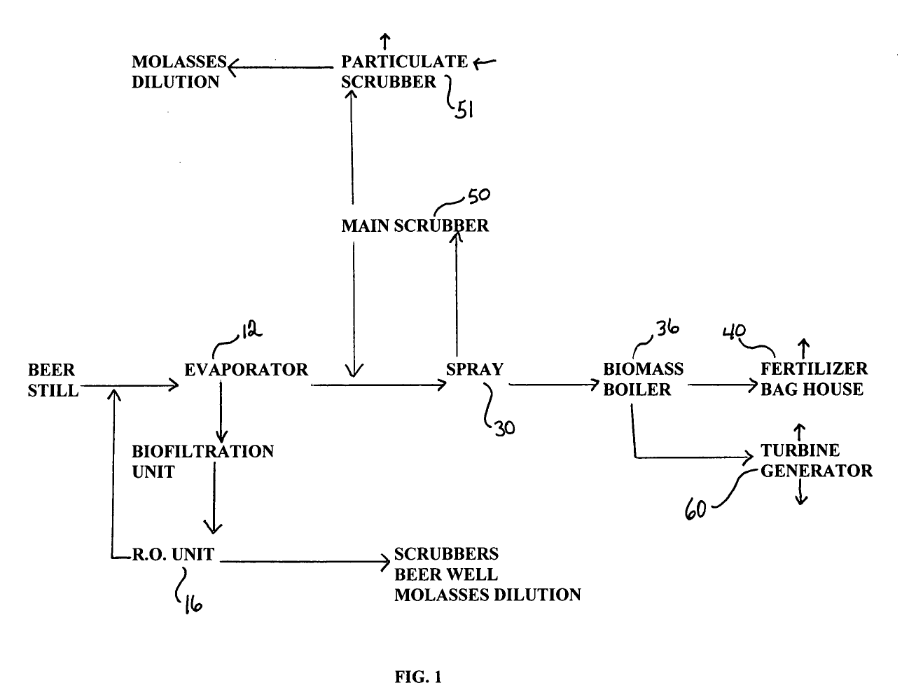

A preferred embodiment of the invention utilizing molasses as feed is disclosed in FIG. 1. The process of the invention is comprised of Fermentation, Stage I; Drying, Stage II; Energy Conversion, Stage III; and Scrubber, Stage IV. The preferred apparatus is as follows:

A beer still 10 for containing thin stillage 11 remaining after distillation of alcohol is fluidly connected to means for evaporating liquid 12 from said stillage 11 to form condensed stillage and condensing the evaporated gases back to a liquid state (condensate 15) resulting also in a first waste stream 14. An evaporator may be obtained from several manufacturers including Swenson Technology, Inc. Means for cleaning the condensate 16 is in fluid connection with said means for evaporating 12. Said means for cleaning the condensate 16 may comprise reverse osmosis filters resulting in a retentate 18 and nearly or pure water as a permeate 20. Reverse osmosis systems are also readily available and can be obtained from Koch Membrane System and GEA Liquid Processing, Scandinavia.

Additional means for drying the thin or condensed stillage 30, preferably a spray dryer, dries the condensed stillage 11 to a biomass 32 resulting in a second waste stream 34. Spray dryers of the capacity necessary for the present invention can be obtained from Anhydro, Denmark and GEA Group Aktiengesellschaft. In the preferred embodiment, the biomass 32 is between about 80% and 99% total solids by weight. Thereafter, the biomass 32 is transferred to means for combusting biomass 36 which, in the preferred embodiment, comprises a biomass boiler. Adequate biomass boilers are available on the commercial market from Energy Products of Idaho (EPI), and Hurst Boiler & Welding Company, Inc. Upon combustion, ash 38 is formed and is collected in a baghouse 40, and third 42 and fourth 41 waste streams are produced. In the preferred embodiment, high heat gases 41 are produced and transfer heat via boiler tubes filled with water to create high pressure steam 44 and the loss of heat from the high heat gases 41 results in the cooler third waste stream 42.

At least one, and typically a plurality of means for removing pollutants from a gaseous stream 50-55 are employed to remove pollutants (heat and particulate) from waste streams 14, 34, 42, and 41 generated by the above apparatus. Preferably, said plurality of said means to remove pollutants comprises at least a Main Scrubber 50 and most preferably includes a Particulate Scrubber 51, yeast Dryer Scrubber 52, Tank Farm Scrubber 53, Distill Vent Scrubber 54 and Fermenter Scrubber 55. In general, the permeate 20 is sent to at least one, and preferably the plurality of scrubbers 50-55 for use therein. The first waste stream 14 is sent to the Main Scrubber 50. The second waste stream 34 is sent to the Main Scrubber 50. The fourth waste stream 41 comprises high heat gases and transfers heat via boiler tubes filled with water to produce high pressure steam 44 and resulting in the cooler third waste stream 42. The high pressure steam 44 is sent to a means for generating power 60. The cooler third waste stream 42 is sent to the spray drier 30. In the preferred embodiment, said means for generating power comprises a turbine. Also in the preferred embodiment, a fifth waste stream 62 comprising low pressure steam results from the electricity generation. This fifth waste stream 62 is made available to other parts of the apparatus.

In the preferred embodiment, the Main Scrubber 50 produces two outputs; a first output 70 of heated air is provided to the spray dryer 30 and a second output 72 is provided to a particulate scrubber 51. The Particulate Scrubber 51, in turn, cools the second output 72 to a partially cooled stream 74 for use by other parts of the apparatus or a cooled stream 76 which is exhausted to the atmosphere.

The present invention is embodied by the following process description: During Stage I, a biofuel is fermented and then distilled by any of a variety of methods known in the prior art. Any one or a combination of a variety of biofuels may be employed including but not limited to agricultural residues (straws, corn stalks, cobs, bagasse, cotton gin trash, etc.), grasses, sorghum, trees, paper, wood wastes, green wastes (leaves, grass, vegetables, etc.) corn, molasses, switchgrass, rice hulls, along with a variety of different methods for converting the biofuel to sugars which can be fermented. One example of such a method comprises diluting molasses with water, admixing the diluted molasses with a yeast solution to form a fermentation solution, and removing heat from the fermentation mixture and holding at the optimum temperature so that yeast population and aeration cause efficient formation of alcohol. In Stage I of the present invention, the alcohol is distilled by employing a distillation process which removes the alcohol and leaves the liquid-solubles mixture called “thin stillage” 11 in the vessel known as the beer still 10.

In Stage II, the stillage 11 is concentrated by subjecting it to an evaporation process to reduce the liquid proportion of the stillage creating condensed stillage. After liquid is evaporated to gas, the gas is condensed to form the condensate 15. The condensate 15 is sent to said means for cleaning the condensate 16 comprising a reverse osmosis system and process in the preferred embodiment. Whereafter the resulting purified water 20 is sent to various other subprocesses and equipment as needed in other Stages. The retentate 18 remaining after reverse osmosis is recycled back into the evaporation process.

The stillage 11 remaining after evaporation in Stage II is often called “thick or condensed stillage”. In the preferred embodiment of the present invention, the condensed stillage is preferably about 50% solids and somewhere in the neighborhood of 70% of those are organic solids. The condensed stillage resulting from molasses fermentation comprises a low value as a feed supplement (as does stillage produced from some other biofuels) and there is no profitable market for it as of this date. Excess heat from the evaporation process is recycled to Stage IV, as described below.

Stage II further comprises said means for drying the stillage 30. In the preferred embodiment, said means for drying includes a drying process wherein the condensed stillage is dried by the spray dryer 30 to form the biomass 32. The biomass 32 may then be combusted or partially combusted in Stage III or sold as a byproduct of the ethanol production process. After spray drying, the biomass 32 of the preferred embodiment comprises between about 80% and 99% total solids by weight. Heat utilized by the spray drying process is at least partially supplied by the Main Scrubber 50 as its first output 70 and partially from the processes in Stage III as the third waste stream 42 to be more fully described below. The heat supplied 70 by the Main Scrubber in the preferred embodiment is between about 150 and 170 degrees Fahrenheit. Heat excess in the form of the second waste stream 34 comprises exhaust from the spray drying process and is exported to the Main Scrubber 50. In the preferred embodiment, the exhaust 34 from the spray drying process is between about 180 and about 220 degrees Fahrenheit.

In Stage III, the biomass 32 is transferred to said means for combusting biomass 36 where it is combusted to produce the third 42 and fourth 41 waste streams (preferably high heat flue gas and reduced heat flue gas, respectively) and ash 38. In the preferred embodiment, the third waste stream 42 is routed back to the spray dryer 30 for the spray drying process and is at a temperature between about 630 and 750 degrees Fahrenheit, most preferably between about 650 to 700 degrees.

The fourth waste stream 41 of the preferred embodiment comprises high heat flue gas which is allowed to contact boiler tubes filled with water. This creates high pressure steam 44 and reduced heat flue gas 42. Said high pressure steam 44 is conveyed to said means for generating power 60. Preferably, said means 60 comprises a turbine generator (as is well-known in the art). The high pressure steam 44 produced by the fourth waste stream 41 in the preferred embodiment includes pressure of between about 150 and 600 psig and a temperature of between about 350 and 500 degrees Fahrenheit, most preferably about 200 psig and 400 degrees. Said means for generating power 60 may exhaust the fifth waste stream 62 comprising low pressure steam which can be used as a heat source for other parts of the process. In the preferred embodiment, the turbine generator expels low pressure steam of between about 10 and 50 psig and between about 250 and 300 degrees Fahrenheit. This low pressure steam is preferably used as a heat source for fermentation or distillation.

A portion of the ash 38 produced by combustion is carried in a gaseous stream to the baghouse 40 where it is collected by means well-known in the art. The remaining ash 38 is discharged by the boiler. After the ash 38 is collected, a gaseous stream is expelled into the atmosphere or sent to one of said plurality of means to remove pollutants 50-55 for further purification. In the preferred embodiment, ash 38 is at least about 30% potash, however, ash created from biomass sourced from a different biofuel is expected to have varying contents and proportions.

Stage IV comprises said plurality of means for removing pollutants 50-55 including particulate, heat, and other pollutants out of the various waste streams produced in Stages I through III. At a minimum, Stage IV employs said Main Scrubber 50, and preferably employs said plurality of scrubbers 50-55. In the preferred embodiment, waste streams from the evaporation process (the first waste stream 14) and the spray drying process (the second waste stream 34) are sent to the Main Scrubber 50; the second waste stream 34 from the spray drying process is between about 180 degrees Fahrenheit and about 220 degrees. The Main Scrubber 50 returns the first output 70 comprising a heated stream to the spray drying process for use as heat and air. Generally, the first output 70 should be above about 130 degrees to be useful in the spray drying process. The Main Scrubber 50 sends its second output 72 (generally under 200 degrees) to the Particulate Scrubber 51 where particles and more heat are removed. The Particulate Scrubber 51 may expel cleaned and cooled gas 76 to the atmosphere or provide cleaned and semi-cooled gas 74 to other portions of the process where heat is required, or both.

Thus, the present invention has been described in an illustrative manner. It is to be understood that the terminology that has been used is intended to be in the nature of words of description rather than of limitation.

Many modifications and variations of the present invention are possible in light of the above teachings. For example, the biofuel may be other than molasses; the high heat waste from combustion could be used for other purposes; the power produced by the turbine could be sold on the grid, etc. Therefore, within the scope of the appended claims, the present invention may be practiced otherwise than as specifically described.

What is claimed is:

1. A method for producing alcohol comprising fermenting a biofuel with yeast to produce an alcohol, distilling off the alcohol leaving stillage, drying the stillage with a spray dryer to form a biomass, and combusting said biomass to produce a high heat waste stream and transferring heat from said high heat waste stream to produce high pressure steam and a cooler waste stream comprising flue gas.

2. The method of claim 1 further comprising expanding said high pressure steam in a turbine to produce power and extracting heat from said flue gas and transferring the extracted heat to the spray dryer.

3. The method of claim 1 further comprising forming ash during combustion and collecting said ash in a baghouse.

4. The method of claim 2 further comprising evaporating liquid from the stillage before drying with a spray dryer, condensing the evaporated liquid to a condensate, cleaning the condensate to produce substantially pure water, and providing said substantially pure water for fermenting the biofuel with yeast.

5. A method of producing alcohol comprising the following process steps:
a) a fermentation process comprising a biofuel to which yeast is added resulting in the production of a liquid solid mixture wherein an alcohol is present;
b) a distillation process comprising removal of alcohol and production of stillage wherein said stillage comprises between about 8% and 20% total solids by weight;
c) an evaporation process comprising removal of at least a portion of liquid from said stillage, condensing said liquid to a condensate, cleaning said condensate, and producing generally pure water, a first waste stream, and condensed stillage;
d) a drying process comprising removal of additional liquid from said condensed stillage by spray drying and producing a second waste stream and biomass;
e) a combustion process comprising combusting said biomass and producing ash, a high heat fourth waste stream, and a cooler third waste stream;
f) a transfer process comprising transferring heat from said fourth waste stream to water for producing high pressure steam;
g) a power production process comprising expanding said relatively high pressure steam for conversion to power and producing a fifth waste steam comprising relatively low pressure steam; and
h) an ash collection process comprising collection of said ash by a baghouse.

6. The method as claimed in claim 5 further comprising a recycling process wherein said power is recycled to at least one other process step wherein power is required, said third waste stream is recycled to said drying process to provide heat and air; said second waste stream is cleaned by at least one of a plurality of means to remove pollutants and then recycled to the drying process to provide heat and air, and said low pressure steam is recycled to at least one other process step where heat is required.

7. The method as claimed in claim 5 wherein said relatively high pressure steam of said fourth waste stream comprises pressure between about 150 and 600 psig and temperature of between about 350 and 500 degrees Fahrenheit.

8. The method as claimed in claim 5 wherein said biomass comprises at least about 80% total solids by weight.

9. The method as claimed in claim 5 wherein said third waste stream comprises flue gas between about 650 and 750 degrees Fahrenheit.

10. The method as claimed in claim 8 wherein said ash comprises at least about 25% potash by weight.

11. A method of producing alcohol comprising the following steps:
a) a fermentation and distillation step comprising fermenting sugars from a biofuel with yeast, distilling off the alcohol produced, and producing stillage;
b) a drying step comprising drying said stillage from between about 10% and 20% total solids by weight to between about 80% and 99% total solids by weight to produce a biomass;
c) a combustion step comprising combusting said biomass and producing: a waste stream of relatively high heat, a cooler waste stream for use in the drying step, and ash; and
d) a power production step comprising transferring a portion of heat from the high heat waste stream to water, producing high pressure steam, and expanding said high pressure steam; and
e) said production step converts the high heat waste stream to said cooler waste stream.

12. The method as claimed in claim 11 wherein said power production step comprises means to produce power.

13. The method as claimed in claim 12 wherein said means to produced power comprises a turbine generator for expanding said high pressure steam.

14. The method as claimed in claim 11 wherein the drying step comprises drying said stillage with a spray dryer.

15. A method of producing alcohol comprising the following steps:
a) a fermentation and distillation step comprising fermenting sugars from a biofuel with yeast, distilling off the alcohol produced, and producing stillage;
b) a drying step comprising spray drying said stillage to produce a biomass of between about 80% and about 99% total solids by weight.

16. The method claimed in claim 15 further comprising a combustion step wherein said biomass is combusted to form an ash for use as a fertilizer, a high heat waste stream, a high pressure steam, and a cooler waste stream of between about 650 and 750 degrees Fahrenheit.

17. The method claimed in claim 16 further comprising employing the high pressure steam to produce power used by other steps in the method and transferring said cooler waste stream to said drying step.

18. An apparatus for producing an alcohol comprising:
a) stillage produced by fermenting a biofuel and from which alcohol has been removed, said stillage comprising a liquid and soluble solids;
b) a beer still;
c) means for evaporating said liquid from said stillage and condensing the evaporated gases to a condensate and producing a condensed stillage; and
d) means for drying said condensed stillage to a biomass having at least about 80% total solids by weight.

19. The apparatus claimed in claim 18 further comprising means for combusting said biomass thereby producing ash and means for generating power.

20. The apparatus claimed in claim 19 further comprising means for removing pollutants from a gaseous stream.

21. The apparatus claimed in claim 20 wherein said means for drying comprises a spray dryer; means for combusting said biomass comprises a biomass boiler and produces a high heat waste stream; means for producing power comprises transferring heat from said high heat waste stream to produce a cooler waste stream and high pressure steam, and a turbine generator for expanding said high pressure steam to produce electrical power.

22. The apparatus claimed in claim 21 wherein said cooler waste stream is employed by said spray dryer to dry the stillage.

23. The apparatus claimed in claim 18 further comprising a baghouse for collecting said ash.

24. The apparatus claimed in claim 20 wherein said means for removing pollutants form a gaseous stream comprise a plurality of scrubbers.
